(19) United States
(12) Patent Application Publication
(10) Pub. No.: US 2015/0372304 A1
(43) Pub. Date: Dec. 24, 2015

(54) POSITIVE ELECTRODE FOR NONAQUEOUS ELECTROLYTE SECONDARY BATTERY AND NONAQUEOUS ELECTROLYTE SECONDARY BATTERY

(71) Applicant: SANYO ELECTRIC CO., LTD., Daito-shi, Osaka (JP)

(72) Inventors: Kazuhiro Hasegawa, Hyogo (JP); Atsushi Kawamura, Hyogo (JP); Sho Tsuruta, Hyogo (JP); Atsushi Fukui, Hyogo (JP)

(73) Assignee: SANYO ELECTRIC CO., LTD., Daito-shi, Osaka (JP)

(21) Appl. No.: 14/764,728

(22) PCT Filed: Oct. 4, 2013
(86) PCT No.: PCT/JP2013/005928

§ 371 Date: Jul. 30, 2015

(30) Foreign Application Priority Data
Jan. 31, 2013 (JP) 2013-017614

(51) Int. Cl. H01M 4/62; H01M 4/38; H01M 4/13

(52) U.S. Cl. CPC H01M 4/62; H01M 4/13; H01M 4/382; H01M 2004/028

(57) ABSTRACT

A nonaqueous electrolyte secondary battery that has high capacity and good load properties. A nonaqueous electrolyte secondary battery includes a positive electrode for a nonaqueous electrolyte secondary battery, a negative electrode, a separator interposed between the positive electrode for a nonaqueous electrolyte secondary battery and the negative electrode, and an electrolyte. The positive electrode for a nonaqueous electrolyte secondary battery includes a positive electrode current collector and a positive electrode active material layer disposed on the positive electrode current collector, the positive electrode active material layer containing a positive electrode active material and a positive electrode additive. The positive electrode additive contains a Li-containing compound that generates gas at 4.2 V (vs. Li/Li⁺) or less during first charging of the nonaqueous electrolyte secondary battery. The positive electrode active material layer has a porosity of 30% or less before the first charging of the nonaqueous electrolyte secondary battery.

### TECHNICAL FIELD

The present invention relates to a positive electrode for a nonaqueous electrolyte secondary battery and a nonaqueous electrolyte secondary battery.

### BACKGROUND ART

Capacities of nonaqueous electrolyte secondary batteries can be increased by increasing the capacities of active materials, increasing the charge voltage of batteries, and/or compressing at high pressure electrodes to which negative and positive electrodes have been applied so as to decrease the porosity of electrodes per unit volume. However, decreasing the porosity of electrodes decreases the amount of the electrolyte liquid retained in the electrodes and decreases the Li ion diffusibility. Thus, there has been a problem of degradation of load properties and low-temperature properties.

To address this, for example, PTL 1 proposes a nonaqueous electrolyte battery that includes a positive electrode having a porosity of 25% or less, in which an electrolyte that has a salt concentration exceeding a concentration that yields a conductivity peak is used.

PTL 2 is directed to a wound-type lithium ion secondary battery including a positive electrode with a porosity in the range of 28% to 40% by volume and proposes a technique of regulating the amount of the electrolyte solution by using two types of carbon in the positive electrode.

### CITATION LIST

### Patent Literature

PTL 1: Japanese Published Unexamined Patent Application No. 2013-173821

PTL 2: Japanese Published Unexamined Patent Application No. 2003-242966

### SUMMARY OF INVENTION

### Technical Problem

Unfortunately, in the case where the porosity of a positive electrode is decreased to 30% or less to increase the battery capacity, degradation of load properties is still significant according to the above-described techniques.

An object of the present invention is to provide a positive electrode for a nonaqueous electrolyte secondary battery that has high capacity and good load properties, and a nonaqueous electrolyte secondary battery that has high capacity and good load properties.

### Solution to Problem

An embodiment of the present invention provides a positive electrode for a nonaqueous electrolyte secondary battery. The positive electrode includes a positive electrode current collector and a positive electrode active material layer disposed on the positive electrode current collector. The positive electrode active material layer contains a positive electrode active material and a positive electrode additive. The positive electrode additive contains a Li-containing compound that generates gas at 4.2 V (vs. Li/Li⁺) or less during first charging of a nonaqueous electrolyte secondary battery that includes the positive electrode for a nonaqueous electrolyte secondary battery. The positive electrode active material layer has a porosity of 30% or less before the first charging of the nonaqueous electrolyte secondary battery.

Another embodiment of the present invention provides a nonaqueous electrolyte secondary battery that includes a positive electrode for a nonaqueous electrolyte secondary battery, a negative electrode, a separator interposed between the positive electrode and the negative electrode, and a nonaqueous electrolyte. The positive electrode for a nonaqueous electrolyte secondary battery includes a positive electrode current collector and a positive electrode active material layer disposed on the positive electrode current collector, and the positive electrode active material layer contains a positive electrode active material and a positive electrode additive. The positive electrode additive contains a Li-containing compound that generates gas at 4.2 V (vs. Li/Li⁺) or less during first charging of the nonaqueous electrolyte secondary battery. The positive electrode active material layer has a porosity of 30% or less before the first charging of the nonaqueous electrolyte secondary battery.

Another embodiment of the present invention provides a nonaqueous electrolyte secondary battery that includes a positive electrode, a negative electrode, a separator interposed between the positive electrode and the negative electrode, and a nonaqueous electrolyte. The positive electrode includes a positive electrode current collector and a positive electrode active material layer disposed on the positive electrode current collector. The positive electrode active material layer contains a positive electrode active material and a positive electrode additive, and the positive electrode additive contains a Li-containing compound that generates gas at 4.2 V (vs. Li/Li⁺) or less during first charging of the nonaqueous electrolyte secondary battery. The positive electrode active material layer has a porosity of 33% or less after the first charging of the nonaqueous electrolyte secondary battery.

An embodiment of the present invention provides a positive electrode for a nonaqueous electrolyte secondary battery. The positive electrode includes a positive electrode current collector and a positive electrode active material layer disposed on the positive electrode current collector. The positive electrode active material layer contains a positive electrode active material and a positive electrode additive. The positive electrode additive contains a Li-containing compound that generates gas at 4.2 V (vs. Li/Li⁺) or less during first charging of a nonaqueous electrolyte secondary battery that includes the positive electrode for a nonaqueous electrolyte secondary battery. The positive electrode active material layer has a porosity of 30% or less before the first charging of the nonaqueous electrolyte secondary battery. The porosity of the positive electrode active material layer after the first charging is higher than the porosity of the positive electrode active material layer before the first charging.

### Advantageous Effects of Invention

According to the present invention, a positive electrode for a nonaqueous electrolyte secondary battery that has high capacity and good load properties, and a nonaqueous electrolyte secondary battery that has high capacity and good load properties can be provided.

### BRIEF DESCRIPTION OF DRAWINGS

FIG. 1 is a schematic cross-sectional view of an example of a structure of a nonaqueous electrolyte secondary battery according to an embodiment.

### DESCRIPTION OF EMBODIMENTS

Embodiments of the present invention will now be described. The embodiments are merely illustrative examples of implementing the present invention and do not limit the present invention.

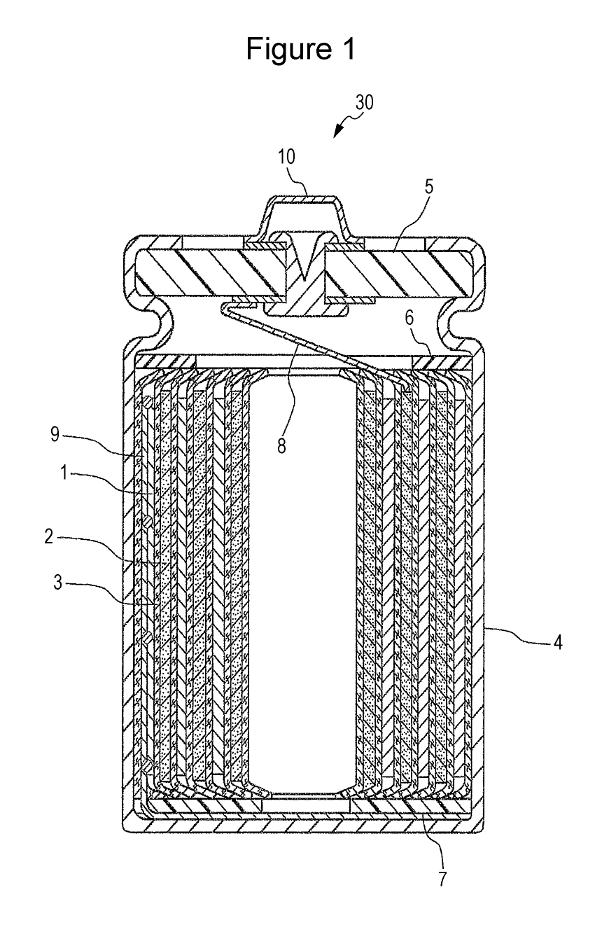

FIG. 1 is a schematic cross-sectional view of an example of a structure of a nonaqueous electrolyte secondary battery according to an embodiment. A nonaqueous electrolyte secondary battery 30 shown in FIG. 1 includes a negative electrode 1, a positive electrode 2, a separator 3 interposed between the negative electrode 1 and the positive electrode 2, a nonaqueous electrolyte (not shown), a cylindrical battery case 4, and a sealing plate 5. The nonaqueous electrolyte is placed in the battery case 4. The negative electrode 1 and the positive electrode 2 with the separator 3 therebetween are wound. The negative electrode 1, the positive electrode 2, and the separator 3 constitute a wound electrode group. An upper insulating plate 6 and a lower insulating plate 7 are respectively attached to two ends of the wound electrode group in the longitudinal direction, and the wound electrode group, the upper insulating plate 6, and the lower insulating plate 7 are housed in the battery case 4. One end of a positive electrode lead 8 is connected to the positive electrode 2 and the other end of the positive electrode lead 8 is connected to a positive electrode terminal 10 disposed on the sealing plate 5. One end of a negative electrode lead 9 is connected to the negative electrode 1 and the other end of the negative electrode lead 9 is connected to the inner bottom of the battery case 4. The connection between a lead and a member is established by welding, for example. The opening end of the battery case 4 is crimped to the sealing plate 5 to seal the battery case 4.

The positive electrode 2 includes a positive electrode current collector and a positive electrode active material layer. The positive electrode material layer is preferably provided on each of the two sides of the positive electrode current collector but may be provided on only one of the two sides of the positive electrode current collector. The positive electrode active material layer contains a positive electrode active material and a positive electrode additive. The porosity of the positive electrode active material layer before the first charging of the nonaqueous electrolyte secondary battery is 30% or less. The porosity of the positive electrode active material layer is calculated by using the following equation:

Porosity (%)=(1−amount of positive electrode active material layer per unit area/thickness of positive electrode active material layer/true density of positive electrode active material layer)×100

The positive electrode active material is preferably a known positive electrode active material for use in nonaqueous electrolyte secondary batteries such as lithium ion secondary batteries and does not generate gas at 4.2 V (xs. Li/Li⁺) or less during the first charging of the nonaqueous electrolyte secondary battery.

Examples of the positive electrode active material include lithium-containing complex metal oxides, layered oxides such as lithium cobaltate (LiCoO₂), lithium nickel cobalt manganate (LiNiCoMnO₂), and lithium nickel cobalt aluminate (LiNiCoAlO₂), and oxides with spinel structure such as lithium manganate (LiMn₂O₄). Layered oxides such as lithium cobaltate (LiCoO₂), lithium nickel cobalt manganate (LiNiCoMnO₂), and lithium nickel cobalt aluminate (LiNiCoAlO₂) are preferred for their high volume energy density. The average particle size of the positive electrode active material is, for example, preferably about 1 μm or more and about 100 μm or less.

The positive electrode additive contains a Li-containing compound that generates gas at 4.2 V (vs. Li/Li⁺) or less during first charging of the nonaqueous electrolyte secondary battery. Although the mechanism of gas generation is not clear, it is assumed that gas is generated during the first charging of the nonaqueous electrolyte secondary battery and during the potential elevation (up to 4.2 V (vs. Li/Li⁺)) at the positive electrode due to partial decomposition of the Li-containing compound or the like, for example. Note that when the Li-containing compound is an oxide, the gas generated is mainly oxygen. The first charging of the nonaqueous electrolyte secondary battery refers to a charging operation with which the positive electrode potential reaches for the first time the potential at which the Li-containing compound decomposes and generates gas.

As described above, in order to increase the capacity of a nonaqueous electrolyte secondary battery, it is preferable to increase the fill density of the positive electrode active material and increase the density of the positive electrode active material layer on a positive electrode current collector. However, increasing the density of the positive electrode active material layer decreases the porosity of the positive electrode active material layer, readily results in insufficient penetration of the nonaqueous electrolyte into the positive electrode active material layer, and degrades load properties. The capacity can be increased by decreasing the porosity of the positive electrode active material layer before the first charging to 30% or less as in the nonaqueous electrolyte secondary battery 30 of this embodiment. However, decreasing the porosity of the positive electrode active material layer before the first charging to 30% or less usually results in insufficient penetration of the nonaqueous electrolyte and degradation of load properties.

In this embodiment, gas generated by decomposition of the Li-containing compound and the like during the first charging of the nonaqueous electrolyte secondary battery renders it easy for the nonaqueous electrolyte (electrolyte solution) to penetrate into the positive electrode active material layer and suppresses degradation of the load properties even when the porosity of the positive electrode active material layer before the first charging is 30% or less. The mechanism with which penetration of the nonaqueous electrolyte into the positive electrode active material layer is promoted by gas evolution is not clear. It is assumed, for example, that the generated gas creates pores in the positive electrode active material layer and changes the state of the interior of the positive electrode active material layer such that the nonaqueous electrolyte is more easily drawn into the positive electrode active material layer. Another possible explanation for the enhanced penetration of the nonaqueous electrolyte into the positive electrode active material layer is, for example, that as the generated gas is released from the positive electrode active material layer, paths through which gas is released are formed in the positive electrode active material layer and the nonaqueous electrolyte penetrates into the positive electrode active material layer through these paths. In particular, the electrolyte solution is selectively supplied to the surface of the active material even when the amount of gas generated is small or the increase in porosity is small. It is presumed that due to this, the load properties are improved. As such, in this embodiment, the capacity is increased while suppressing degradation of load properties since the porosity of the positive electrode active material layer before the first charging of the nonaqueous electrolyte secondary battery is decreased to 30% or less and a positive electrode active material layer containing a Li-containing compound that generates gas at 4.2 V (vs. Li/Li⁺) or less during the first charging is used.

The Li-containing compound used in this embodiment may be any compound that generates gas at 4.2 V (vs. Li/Li⁺) or less during the first charging of the nonaqueous electrolyte secondary battery. The Li-containing compound preferably has an antifluorite crystal structure since the Li content is high and degradation of load properties can be efficiently suppressed by addition of a small amount of such a compound, for example. The Li-containing compound is more preferably a compound represented by general formula LiₓM_{y}O₄ (x=4 to 7, y=0.5 to 1.5, and M represents at least one metal selected from Co, Fe, Mn, Zn, Al, Ga, Ge, Ti, Si, and Sn). An antifluorite crystal structure is a structure in which tetrahedral sites of a face-centered cubic lattice constituted by anions having negative charges are occupied by cations having positive charges. In other words, each unit lattice includes four anions and possibly a maximum of eight cations. Examples of the Li-containing compound having an antifluorite crystal structure include Li₂O and the like in which the anions are mainly oxygen and the cations are mainly lithium, and Li₆CoO₄, LisFeO₂, Li₆MnO₄, Li₆ZnO₄, Li₅AlO₄, Li₅GaO₄, and the like in which the anions are mainly oxygen and the cations are lithium and at least one transition metal element or the like.

The content of the Li-containing compound in the positive electrode active material layer is preferably 0.1% by mass or more and less than 10% by mass and more preferably 0.2% by mass or more and less than 10% by mass in order to suppress degradation of the load properties and the like. If the content of the Li-containing compound is outside the above-described range, degradation of the load properties may not be sufficiently suppressed.

A rare earth element is preferably attached to a surface of the positive electrode active material in order to promote decomposition of the Li-containing compound and further improve load properties. The rare earth element to be attached is preferably at least one element selected from praseodymium, neodymium, erbium, samarium, europium, gadolinium, terbium, dysprosium, holmium, thulium, ytterbium, and lutetium and more preferably at least one element selected from praseodymium, neodymium, and erbium. The rare earth element to be attached is preferably in a compound state such as an oxide or a hydroxide. The amount of the rare earth element attached is preferably 0.005% by mass or more and 1.0% by mass or less and more preferably 0.01% by mass or more and 0.3% by mass or less on a rare earth elemental basis. If the amount of the rare earth compound attached is less than 0.005% by mass, the load properties may not be sufficiently improved. In contrast, if the amount of the rare earth compound attached exceeds 1.0% by mass, significant polarization may occur and the load properties may not be sufficiently improved.

Generally, first charging is usually performed before shipping a nonaqueous electrolyte secondary battery as a product. According to the nonaqueous electrolyte secondary battery 30 of this embodiment, decomposition of the Li-containing compound generates gas during the first charging and thus the density or the like of the positive electrode active material layer is decreased. In other words, in the nonaqueous electrolyte secondary battery 30 of this embodiment, the porosity of the positive electrode active material layer after the first charging is usually higher than the porosity of the positive electrode active material layer before the first charging. The inventors of the present invention have conducted extensive studies on the relationship between the porosity of the positive electrode active material before the first charging and that after the first charging and found that it is possible to suppress degradation of the load properties while achieving high capacity if the nonaqueous electrolyte secondary battery 30 of this embodiment includes a positive electrode active material layer that contains a Li-containing compound that generates gas at 4.2 V (vs. Li/Li⁺) or less during the first charging of the nonaqueous electrolyte secondary battery and that has porosity of 33% or less after the first charging. Moreover, as long as the nonaqueous electrolyte secondary battery 30 of this embodiment includes a positive electrode active material layer that contains a Li-containing compound that generates gas at 4.2 V (vs. Li/Li⁺) or less during the first charging and that has a porosity of 30% or less before the first charging, the porosity of the positive electrode active material layer after the first charging may be higher than the porosity of the positive electrode active material layer before the first charging. The porosity of the positive electrode active material layer after the first charging need be 33% or less and is preferably 15% or more and 30% or less.

In the case where a Li-containing compound represented by general formula LiₓM_{y}O₄ (x=4 to 7, y=0.5 to 1.5, and M represents at least one metal selected from Co, Fe, Mn, Zn, Al, Ga, Ge, Ti, Si, and Sn) is used, the Li-containing compound preferably turns into a Li-containing compound represented by general formula LiₓM_{y}O₄ (x≦3, y=0.5 to 5.5, and M represents at least one metal selected from Co, Fe, Mn, Zn, Al, Ga, Ge, Ti, Si, and Sn) after charging and discharging in order to suppress degradation of load properties, for example. If x is 3 or more, the amount of gas generated during the first charging may be decreased due to a lower amount of the decomposed Li-containing compound and the load properties may not be sufficiently improved. The transition metal M in the Li-containing compound is preferably Fe. This is presumably because if the Li-containing compound is Li₆CoO₄ or Li₆MnO₄, cobalt oxides or manganese oxides, which are formed by decomposition of the Li-containing compound during the first charging and are more unstable and easily dissolvable than iron oxides resulting from decomposition of Li₅FeO₄, may precipitate on the negative electrode and degrade properties.

The average particle size of the Li-containing compound is, for example, preferably in about 1 μm or more and about 100 μm or less.

The positive electrode active material layer may contain a binder, a conductive agent, and the like in addition to the positive electrode active material and the Li-containing compound described above. Specific examples of a preferable binder include carboxymethyl cellulose and styrene butadiene rubber.

The thickness of the positive electrode current collector is not particularly limited but is preferably 1 μm or more and 500 μm or less. The positive electrode current collector is, for example, composed of a known conductive material used in nonaqueous electrolyte secondary batteries such as lithium ion batteries. For example, the positive electrode current collector is a nonporous conductive substrate.

The negative electrode 1 includes a negative electrode current collector and a negative electrode active material layer disposed on the negative electrode current collector. The negative electrode active material layer is preferably provided on each of the two sides of the negative electrode current collector but may be provided on only one of the two sides of the negative electrode current collector.

The negative electrode current collector is, for example, composed of a known conductive material used in nonaqueous electrolyte secondary batteries such as lithium ion batteries. The thickness of the negative electrode current collector is, for example, preferably about 1 μm or more and about 500 μm or less.

The negative electrode active material is, for example, a known negative electrode active material used in nonaqueous electrolyte secondary batteries such as lithium ion batteries. Examples thereof include carbon active materials, alloy active materials, and mixtures of carbon active materials and alloy active materials. Examples of the carbon active materials include artificial graphite, natural graphite, non-graphitizable carbon, and graphitizable carbon. Examples of the alloy active materials include materials that intercalate lithium by alloying with lithium during charging at a negative electrode potential and deintercalate lithium during discharging. Examples thereof include silicon active materials that contain silicon. Examples of the preferable silicon active materials include silicon, silicon compounds, and substitution products and solid solutions of these. A preferable example of the silicon compound is silicon oxide represented by SiOₐ (0.05<a<1.95). From the viewpoint of further enhancing the charge/discharge capacity of the nonaqueous electrolyte secondary battery 30 and the like, the negative electrode active material layer preferably contains an alloy active material and more preferably contains silicon. The negative electrode active material layer may contain one negative electrode active material or plural negative electrode active materials.

The average particle size of the negative electrode active material is preferably about 1 μm or more and about 100 μm or less. The negative electrode active material layer preferably contains a binder, a conductive agent, and the like in addition to the negative electrode active material. Specific examples of the preferable binder include carboxymethyl cellulose and styrene butadiene rubber.

A sheet or the like composed of a resin or the like that has particular ion permeability, mechanical strength, insulation properties, and the like is used as the separator 3, for example. The thickness of the separator 3 is, for example, preferably about 10 μm or more and about 300 μm or less. The porosity of the separator 3 is preferably about 30% or more and about 70% or less. A porosity is a percentage of a total volume of fine pores in the separator 3 relative to the volume of the separator 3.

A nonaqueous solvent in which a lithium salt is dissolved is preferably used as the nonaqueous electrolyte. LiPF₆, LiBF₄, or the like can be used as the lithium salt, for example. Ethylene carbonate (EC), propylene carbonate (PC), dimethyl carbonate (DMC), diethyl carbonate (DEC), ethyl methyl carbonate (EMC), or the like can be used as the nonaqueous solvent, for example. These are preferably used in combination.

The nonaqueous electrolyte secondary battery 30 shown in FIG. 1 is a cylindrical battery that includes a wound electrode group. However, the form of battery is not particularly limited and a prismatic battery, a flat battery, a coin battery, a laminate film pack battery, or the like may be used.

### EXAMPLES

The present invention will now be described in further detail by using examples below which do not limit the present invention.

### Example 1-1

### Preparation of a Positive Electrode Active Material

Li₂CO₃ serving as a Li source and an oxide represented by Co₃O₄ were mixed with each other by using an Ishikawa-type grinder mortar so that the molar ratio of Li to the transition metal element was 1:1. The resulting mixture was heat-treated at 950° C. for 20 hours in an air atmosphere and crushed. As a result, LiCoO₂ having an average secondary particle size of about 16 μm was obtained.

### [Preparation of a Li-Containing Compound Serving as a Positive Electrode Additive]

Li₂O serving as a Li source and an oxide represented by Fe₂O₃ were mixed with each other by using an Ishikawa-type grinder mortar so that the molar ratio of Li to the transition metal element was 5:1. The resulting mixture was heat-treated at 600° C. for 12 hours in a nitrogen atmosphere and crushed. As a result, Li₅FeO₄ having an average secondary particle size of about 10 μm was obtained. A three-pole cell described below was prepared by using a positive electrode composed of only the positive electrode additive obtained. The three-pole cell was subjected to first charging at a constant current of 15 mA until the potential of the positive electrode was 4.2 V (vs. Li/Li⁺) on a lithium basis. As a result, swelling of the three-pole cell was observed. The gas inside the three-pole cell was analyzed by gas chromatography and oxygen gas was detected as a result. In other words, it was confirmed that the obtained positive electrode additive generated gas at 4.2 V (vs. Li/Li) or less during the first charging.

### [Preparation of a Positive Electrode]

The obtained positive electrode active material (LiCoO₂) and positive electrode additive (Li₅FeO₄) were mixed with each other at a mass ratio of 98:2 to obtain an active material mixture. Then carbon powder serving as a conductive agent, polyvinylidene fluoride (PVdF) serving as a binder, and N-methyl-2-pyrrolidone serving as a dispersant were added to the active material mixture so that the active material mixture/conductive agent/binder ratio was 95:2.5:2.5. The resulting mixture was kneaded to prepare a positive electrode slurry. The positive electrode slurry was applied to both sides of an aluminum foil (thickness: 15 μm) serving as a positive electrode current collector and dried to form positive electrode active material layers on the aluminum foil. The positive electrode active material layers were rolled with a roller to adjust the porosity of each positive electrode active material layer to 27% so as to prepare a positive electrode. Since the positive electrode additive may react with moisture in the air and undergo decomposition, preparation of the positive electrode was conducted in a dry atmosphere with a dew point of −30° C. A positive electrode lead was attached to the obtained positive electrode.

### [Preparation of a Nonaqueous Electrolyte]

Into a mixed solvent containing ethylene carbonate (EC) and ethyl methyl carbonate (EMC) at a volume ratio of 3:7, lithium hexafluorophosphate (LiPF₆) was dissolved so that the concentration was 1.0 mol/L so as to prepare a nonaqueous electrolyte (electrolyte solution).

### [Three-Pole Cell]

A three-pole cell A1 includes a measurement electrode unit that includes the positive electrode obtained as above, a negative electrode (counter electrode: lithium metal), and a separator interposed between the positive electrode and the negative electrode; a reference electrode (lithium metal) disposed at a particular distance from the measurement electrode unit, a nonaqueous electrolyte prepared as above, and an aluminum laminate film serving as an outer casing for housing these components. The inside of the aluminum laminate film housing the measurement electrode unit and the reference electrode is filled with the nonaqueous electrolyte. The negative electrode has dimensions that allow the negative electrode to oppose the positive electrode. The theoretical capacity of the prepared three-pole cell A1 is 100 mAh.

### Example 1-2

A three-pole cell was prepared as in Example 1-1 except that the positive electrode active material (LiCoO₂) and the positive electrode additive (Li₅FeO₄) were mixed at a mass ratio of 96:4 in preparing the positive electrode. This three-pole cell was assumed to be a three-pole cell A2. The porosity of the positive electrode active material layers in the positive electrode in Example 1-2 was 27%.

### Example 1-3

A three-pole cell was prepared as in Example 1-1 except that the positive electrode active material (LiCoO₂) and the positive electrode additive (Li₅FeO₄) were mixed at a mass ratio of 94:6 in preparing the positive electrode. This three-pole cell was assumed to be a three-pole cell A3. The porosity of the positive electrode active material layers in the positive electrode in Example 1-3 was 27%.

### Comparative Example 1

A three-pole cell was prepared as in Example 1-1 except that no positive electrode additive was added and only the positive electrode active material (LiCoO₂) was used. This three-pole cell was assumed to be a three-pole cell A4. The porosity of the positive electrode active material layers in the positive electrode of Comparative Example 1 was 27%.

### [Evaluation of Three-Pole Cells A1 to A4]

A three-pole cell prepared as above was charged at a constant current of 0.15 It (=15 mA) until the potential of the positive electrode was 4.50 V on a lithium basis. Subsequently, charging was conducted at a constant voltage of 4.50 V until the current was 1/50 It (=2 mA). The amount of electricity that flowed during this process was measured to determine the initial charge capacity (mA/g) and the charge capacity (mAh/cc) was calculated by using the equation below:

Charge capacity (mAh/cc)=Initial charge capacity (mAh/g)×density (g/cc) of positive electrode active material layer before charging

Next, discharging was conducted at a constant current of 0.10 It (=10 mA) until the battery voltage was 2.50 V and the amount of electricity flowed during this process was measured to determine the initial discharge capacity (mAh/g). Battery swelling caused by gas evolution was observed in the three-pole cells A1 to A3 after the initial charging. Then charging was conducted under the same conditions as those described above and then discharging was conducted at a constant current of 2.0 It (=200 mA) until the battery voltage was 2.50 V. The amount of electricity flowed during this process was measured to determine the discharge load capacity (mAh/g) and the rate characteristic was calculated by using the equation below:

Rate characteristic (%)=[discharge load capacity (2.0 It)/initial discharge capacity (0.1 It)]×100

After the charging and discharging described above, the three-pole cells A1 to A4 were dismantled, the positive electrodes were taken out, and the porosities of the positive electrode active material layers were measured. The porosity of the positive electrode active material layers of Examples 1-1 to 1-3 was 29% and the porosity of the positive electrode active material layers of Comparative Example 1 was 28%.

Table 1 summarizes the compositions of the positive electrode active materials and the positive electrode additives used in Examples 1-1 to 1-3 and Comparative Example 1, the mixing ratio of the positive electrode additive relative to the positive electrode active material, the porosities of the positive electrode active material layers, and the observed charge capacities and load properties (2.0 It).

TABLE 1

| | | | Positive electrode | Porosity | Porosity after | Charge | Rate |
|---|---|---|---|---|---|---|---|
| | Positive electrode | Positive electrode | additive mixing | before first | charging and | capacity | characteristic |
| | active material | additive | ratio | charging | discharging | (mAh/cc) | (2.0 It) |
| Example 1-1 | LiCoO₂ | Li₅FeO₄ | 2% by mass | 27% | 29% | 711 | 83.3% |
| Example 1-2 | LiCoO₂ | Li₅FeO₄ | 4% by mass | 27% | 29% | 726 | 86.2% |
| Example 1-3 | LiCoO₂ | Li₅FeO₄ | 8% by mass | 27% | 29% | 729 | 87.4% |
| Comparative | LiCoO₂ | None | — | 27% | 28% | 704 | 78.9% |
| Example 1 | | | | | | | |

The results shown in Table 1 indicate that degradation of the rate characteristic was less in Examples 1-1 to 1-3 that used, as the positive electrode additive, a Li-containing compound that generated gas at 4.2 V (vs. Li/Li⁺) or less during the first charging than in Comparative Example 1 in which the Li-containing compound was not added. In all of Examples 1-1 to 1-3 (and Comparative Example 1) in which the porosity of the positive electrode active material layers was 30% or less, a high charge capacity was obtained. Degradation of the rate characteristic is increasingly suppressed as the mixing ratio of the Li-containing compound is increased, as shown by the results in Examples 1-1 to 1-3. An attempt was made to prepare a positive electrode in which the mixing ratio of the Li-containing compound was 10% by mass or more, but gelation of the positive electrode slurry frequently occurred and it was difficult to prepare a positive electrode. Accordingly, the mixing ratio of the Li-containing compound is preferably 2% by mass or more and less than 10% by mass. If the ratio of the Li-containing compound added is less than 2% by mass, a smaller amount of gas is generated and an effect of moderating the porosity of the positive electrode active material layers is smaller compared to when the ratio is 2% by mass or more and thus the rate characteristic is presumably degraded. In the case where a positive electrode containing 10% by mass or more of the Li-containing compound is prepared, the amount of gas generated is larger compared to the case in which the content is less than 10% by mass and thus electronic conduction in the positive electrode active material is presumably impaired and the rate characteristic is presumably degraded.

### Example 2-1

A three-pole cell was prepared as in Example 1-1 except that, in preparing the positive electrode, the positive electrode active material (LiCoO₂) and the positive electrode additive (Li₅FeO₄) were mixed at a mass ratio of 96:4 and the pressure of the roller was adjusted so that the porosity of the positive electrode active material layers in the positive electrode was 20%. This three-pole cell was assumed to be a three-pole cell B1.

### Example 2-2

A three-pole cell was prepared as in Example 1-1 except that, in preparing the positive electrode, the positive electrode active material (LiCoO₂) and the positive electrode additive (Li₅FeO₄) were mixed at a mass ratio of 96:4 and the pressure of the roller was adjusted so that the porosity of the positive electrode active material layers in the positive electrode was 27%. This three-pole cell was assumed to be a three-pole cell B2.

### Example 2-3

A three-pole cell was prepared as in Example 1-1 except that, in preparing the positive electrode, the positive electrode active material (LiCoO₂) and the positive electrode additive (Li₅FeO₄) were mixed at a mass ratio of 96:4 and the pressure of the roller was adjusted so that the porosity of the positive electrode active material layers in the positive electrode was 28%. This three-pole cell was assumed to be a three-pole cell B3.

### Comparative Example 2-1

A three-pole cell was prepared as in Example 1-1 except that, in preparing the positive electrode, no positive electrode additive was added and only the positive electrode active material (LiCoO₂) was used and that the pressure of the roller was adjusted to adjust the porosity of the positive electrode active material layers in the positive electrode to 27%. This three-pole cell was assumed to be a three-pole cell B4.

### Comparative Example 2-2

A three-pole cell was prepared as in Example 1-1 except that, in preparing the positive electrode, no positive electrode additive was added and only the positive electrode active material (LiCoO₂) was used and that the pressure of the roller was adjusted to adjust the porosity of the positive electrode active material layers in the positive electrode to 33%. This three-pole cell was assumed to be a three-pole cell B5.

### Comparative Example 2-3

A three-pole cell was prepared as in Example 1-1 except that, in preparing the positive electrode, the positive electrode active material (LiCoO₂) and the positive electrode additive (Li₅FeO₄) were mixed at a mass ratio of 96:4 and the pressure of the roller was adjusted so that the porosity of the positive electrode active material layers in the positive electrode was 32%. This three-pole cell was assumed to be a three-pole cell B6.

The three-pole cells B1 to B6 were charged and discharged as with the three-pole cell A1 and the charge capacity (mAh/cc) and the rate characteristic (%) were calculated. After the charging and discharging, the three-pole cells B1 to B6 were dismantled, the positive electrodes were taken out, and the porosities of the positive electrode active material layers were measured. The porosity of the positive electrode active material layer in Example 2-1 was 22%, the porosity of the positive electrode active material layers in Example 2-2 was 29%, the porosity of the positive electrode active material layers in Examples 2-3 was 31%, the porosity of the positive electrode active material layers in Comparative Example 2-1 was 28%, and the porosity of the positive electrode active material layers in Comparative Examples 2-2 and 2-3 was 34%.

Table 2 summarizes the compositions of the positive electrode active materials and the positive electrode additives used in Examples 2-1 to 2-3 and Comparative Examples 2-1 to 2-3, the mixing ratio of the positive electrode additive relative to the positive electrode active material, the porosities of the positive electrode active material layers, and the observed charge capacities and load properties (2.0 It).

TABLE 2

| | | | Positive electrode | Porosity | Porosity after | Charge | Rate |
|---|---|---|---|---|---|---|---|
| | Positive electrode | Positive electrode | additive mixing | before first | charging and | capacity | characteristic |
| | active material | additive | ratio | charging | discharging | (mAh/cc) | (2.0 It) |
| Example 2-1 | LiCoO₂ | Li₅FeO₄ | 4% by mass | 20% | 22% | 831 | 82.7% |
| Example 2-2 | LiCoO₂ | Li₅FeO₄ | 4% by mass | 27% | 29% | 726 | 86.2% |
| Example 2-3 | LiCoO₂ | Li₆CoO₄ | 4% by mass | 28% | 31% | 705 | 85.4% |
| Comparative | LiCoO₂ | None | — | 27% | 28% | 704 | 78.9% |
| Example 2-1 | | | | | | | |
| Comparative | LiCoO₂ | None | — | 33% | 34% | 647 | 84.0% |
| Example 2-2 | | | | | | | |
| Comparative | LiCoO₂ | Li₆CoO₄ | 4% by mass | 32% | 34% | 647 | 83.9% |
| Example 2-3 | | | | | | | |

The results shown in Table 2 indicate that degradation of the rate characteristic was less in Examples 2-1 to 2-3 that used, as the positive electrode additive for the positive electrode active material layer, a Li-containing compound that generated gas at 4.2 V (vs. Li/Li⁺) or less during the first charging than in Comparative Examples 2-1 in which no Li-containing compound was added. Compared to Comparative Examples 2-2 and 2-3 in which the porosity of the positive electrode active material layers was more than 30%, Examples 2-1 to 2-3 in which the porosity of the positive electrode active material layers was 30% or less could retain high charge capacities.

The results of Examples 2-1 to 2-3 indicate that compared to Example 2-1 in which the porosity of the positive electrode active material layers was 20%, Examples 2-2 and 2-3 in which the porosity of the positive electrode active material layers was more than 20% but not more than 30% suffered less degradation of the rate characteristic. Presumably, when the porosity of the positive electrode active material layers is 20% or less, the amount of the nonaqueous electrolyte retained does not increase sufficiently despite addition of the Li-containing compound, resulting in degradation of the rate characteristic compared to when the porosity is more than 20%. Accordingly, the porosity of the positive electrode active material layers before the first charging is preferably more than 20% but not more than 30%. In Comparative Example 2-2 in which the porosity of the positive electrode active material layers exceeded 30% before first charging, a rate characteristic comparable to that of Example 2-1 was obtained without addition of the Li-containing compound; however, compared to Example 2-1, the charge capacity was low.

In Example 2-3, the porosity of the positive electrode active material layers after charging was 31%; however, a high charge capacity was retained and degradation of the rate characteristic was suppressed. In Comparative Examples 2-2 and 2-3 in which the porosity of the positive electrode active material layers after charging was 34%, degradation of the rate characteristic was suppressed but a high charge capacity was not obtained. Accordingly, a high capacity is achieved and degradation of the rate characteristic can be suppressed if a Li-containing compound that generates gas at 4.2 V (vs. Li/Li⁺) or less during the first charging is used and the porosity of the positive electrode active material layers after the first charging is 33% or less.

### Example 3-1

A three-pole cell was prepared as in Example 1-1 and was assumed to be a three-pole cell C1. The porosity of the positive electrode active material layers in the positive electrode of Example 3-1 was adjusted to 27%.

### Example 3-2

A three-pole cell was prepared as in Example 1-1 except that, in preparing the positive electrode, the positive electrode active material (LiCoO₂) and the positive electrode additive (Li₅FeO₄) were mixed at a mass ratio of 96:4, and this three-pole cell was assumed to be a three-pole cell C2. The porosity of the positive electrode active material layers in the positive electrode of Example 3-2 was adjusted to 27%.

### Example 3-3

### Preparation of Li₆CoO₄ Serving as a Positive Electrode Additive

Li₂O serving as a Li source and an oxide represented by CoO were mixed with each other by using an Ishikawa-type grinder mortar so that the molar ratio of Li to the transition metal element was 6:1. The resulting mixture was heat-treated at 700° C. for 12 hours in a nitrogen atmosphere and crushed. As a result, Li₆CoO₄ having an average secondary particle size of about 10 μm was obtained.

A three-pole cell was prepared as in Example 1-1 except that, in preparing the positive electrode, Li₆CoO₄ prepared as above was used as the positive electrode additive and the positive electrode active material (LiCoO₂) and the positive electrode additive (Li₆CoO₄) were mixed at a mass ratio of 98:2. This three-pole cell was assumed to be a three-pole cell C3. The porosity of the positive electrode active material layers in the positive electrode of Example 3-3 was adjusted to 27%.

### Example 3-4

A three-pole cell was prepared as in Example 1-1 except that, in preparing the positive electrode, Li₆CoO₄ prepared as above was used as the positive electrode additive and the positive electrode active material (LiCoO₂) and the positive electrode additive (Li₆CoO₄) were mixed at a mass ratio of 96:4. This three-pole cell was assumed to be a three-pole cell C4. The porosity of the positive electrode active material layers in the positive electrode of Example 3-4 was adjusted to 27%.

### Example 3-5

A three-pole cell was prepared as in Example 1-1 except that, in preparing the positive electrode, Li₂O was used as the positive electrode additive and the positive electrode active material (LiCoO₂) and the positive electrode additive (Li₂O) were mixed at a mass ratio of 96:4. This three-pole cell was assumed to be a three-pole cell C5. The porosity of the positive electrode active material layers in the positive electrode of Example 3-5 was adjusted to 27%.

### Example 3-6

### Preparation of Li₆MnO₄ Serving as a Positive Electrode Additive

Li₂O serving as a Li source and an oxide represented by MnO were mixed with each other by using an Ishikawa-type grinder mortar so that the molar ratio of Li and the transition metal element was 6:1. The resulting mixture was heat-treated in a nitrogen atmosphere at 950° C. for 12 hours and crushed. As a result, Li₆MnO₄ having an average secondary particle size of about 10 μm was obtained.

A three-pole cell was prepared as in Example 1-1 except that, in preparing the positive electrode, Li₆MnO₄ obtained as above was used as the positive electrode additive and the positive electrode active material (LiCoO₂) and the positive electrode additive (Li₆MnO₄) were mixed at a molar ratio of 96:4. This three-pole cell was assumed to be a three-pole cell C6. The porosity of the positive electrode active material layers in the positive electrode of Example 3-6 was adjusted to 27%.

### [Evaluation of Three-Pole Cells C1 to C6]

A three-pole cell prepared as above was charged at a constant current of 0.15 It (=15 mA) until the potential of the positive electrode was 4.50 V on a lithium basis. Subsequently, charging was conducted at a constant voltage of 4.50 V until the current was 1/50 It (=2 mA). The amount of electricity that flowed during this process was measured to determine the initial charge capacity (mA/g) and the charge capacity (mAh/cc) was calculated as described above. Then discharging was conducted at a constant current of 0.10 It (=10 mA) until the battery voltage was 2.50 V and the amount of electricity flowed during this process was measured to determine the initial discharge capacity (mAh/g). Battery swelling caused by gas evolution was observed after the initial charging. Then charging was conducted under the same conditions as those described above and then discharging was conducted at a constant current of 0.50 It (=50 mA) until the battery voltage was 2.50 V. The amount of electricity flowed during this process was measured to determine the discharge load capacity (mAh/g) and the rate characteristic was calculated by using the equation below:

Rate characteristic (%)=[discharge load capacity (0.50 It)/initial discharge capacity (0.1 It)]×100

After the charging and discharging described above, the three-pole cells C1 to C6 were dismantled, the positive electrodes were taken out, and the porosities of the positive electrode active material layers were measured. The porosity of the positive electrode active material layers of Examples 3-1 to 3-6 was 29%.

Table 3 summarizes the compositions of the positive electrode active materials and the positive electrode additives used in Examples 3-1 to 3-6, the mixing ratio of the positive electrode additive relative to the positive electrode active material, the porosities of the positive electrode active material layers, and the observed charge capacities and load properties (0.5 It).

TABLE 3

| | | | Positive electrode | Porosity | Porosity after | Charge | Rate |
|---|---|---|---|---|---|---|---|
| | Positive electrode | Positive electrode | additive mixing | before first | charging and | capacity | characteristic |
| | active material | additive | ratio | charging | discharging | (mAh/cc) | (0.5 It) |
| Example 3-1 | LiCoO₂ | Li₅FeO₄ | 2% by mass | 27% | 29% | 711 | 98.3% |
| Example 3-2 | LiCoO₂ | Li₅FeO₄ | 4% by mass | 27% | 28% | 726 | 98.5% |
| Example 3-3 | LiCoO₂ | Li₅CoO₄ | 2% by mass | 27% | 29% | 721 | 96.6% |
| Example 3-4 | LiCoO₂ | Li₆CoO₄ | 4% by mass | 27% | 29% | 723 | 96.0% |
| Example 3-5 | LiCoO₂ | Li₂O | 4% by mass | 27% | 29% | 721 | 95.4% |
| Example 3-6 | LiCoO₂ | Li₆MnO₄ | 4% by mass | 27% | 29% | 725 | 97.4% |

The results shown in Table 3 indicate that degradation of the rate characteristic was less in Examples 3-1 to 3-4, and 3-6 in which Li₅FeO₄, Li₆CoO₄, and Li₆MnO₄ were used as the Li-containing compounds than in Example 3-5 in which Li₂O was used. In particular, in Examples 3-1 and 3-2 in which Li₅FeO₄ was used, degradation of the rate characteristic was further suppressed compared to Examples 3-3, 3-4, and 3-6 in which Li₆CoO₄ and Li₆MnO₄ were used. This is presumably because the elements Co, Mn, and Fe serve as catalysts for decomposition reaction of oxygen in the crystal structure during the first charging, with Fe exhibiting a particularly good catalytic effect, so as to improve the pore-forming state in the positive electrode active material layers.

### Example 4-1

A three-pole cell was prepared as in Example 1-1 except that, in preparing the positive electrode, the positive electrode active material (LiCoO₂) and the positive electrode additive (Li₅FeO₄) were mixed at a mass ratio of 96:4 and this three-pole cell was assumed to be a three-pole cell D1. The porosity of the positive electrode active material layers in the positive electrode of Example 4-1 was adjusted to 27%.

### Example 4-2

### Preparation of a Positive Electrode Active Material Having a Rare Earth Element Attached Thereto

To 3000 parts by mass of pure water, 1000 parts by mass of the LiCoO₂ particles described above were added, followed by stirring, so as to prepare a suspension in which LiCoO₂ was dispersed. Next, to this suspension, a solution prepared by dissolving 1.05 parts by mass of erbium nitrate pentahydrate [Er(NO₃)₃.5H₂O] in 200 parts by mass of pure water was added. In order to control the pH of the solution in which LiCoO₂ was dispersed to 9, a 10% by mass aqueous nitric acid solution or a 10% by mass aqueous sodium hydroxide solution was added. After completion of addition of the erbium nitrate pentahydrate solution described above, suction filtration and washing with water were performed and the resulting powder was dried at 120° C. As a result, LiCoO₂ powder having an erbium hydroxide compound fixed to part of the surface of LiCoO₂ was obtained. The obtained powder was heat-treated at 300° C. for 5 hours in air. Heat-treating the powder at 300° C. converts all or most of erbium hydroxide into erbium oxyhydroxide; thus, a state is created in which erbium oxyhydroxide is fixed to part of the surface of a positive electrode active material particle. However, some of erbium hydroxide may remain and thus there are cases in which erbium hydroxide is attached to part of the surface of a positive electrode active material particle. The obtained positive electrode active material was observed with a scanning electron microscope (SEM) and it was found that an erbium compound having an average particle size of 100 nm or less was fixed to part of surfaces of the positive electrode active material. The amount of the fixed erbium compound measured by ICP was 0.06% by mass relative to LiCoO₂ on an erbium element basis. The BET value of the obtained positive electrode active material was measured and was 0.60 m²/g. The positive electrode active material obtained as such is hereinafter referred to as “coated LCO”.

A three-pole cell was prepared as in Example 1-1 except that, in preparing the positive electrode, the coated LCO obtained as above was used as the positive electrode active material and the positive electrode active material (coated LCO) and the positive electrode additive (Li₅FeO₄) were mixed at a mass ratio of 96:4. This cell was assumed to be a three-pole cell D2. The porosity of the positive electrode active material layers in the positive electrode of Example 4-2 was adjusted to 26%.

### Example 4-3

### Preparation of NCM333 Serving as a Positive Electrode Active Material

Li₂CO₃ and a coprecipitated hydroxide represented by Ni_{1/3}Co_{1/3}Mn_{1/3}(OH)₂ were mixed with each other by using an Ishikawa-type grinder mortar so that the molar ratio of Li to all transition metal elements was 1.08:1. The resulting mixture was heat-treated in an air atmosphere at 950° C. for 20 hours and crushed. As a result, Li_{1.04}Ni_{0.32}Co_{0.32}Mn_{0.32}O₂ (hereinafter referred to as “NCM333”) having an average secondary particle size of about 12 μm was obtained.

A three-pole cell was prepared as in Example 1 except that, in preparing the positive electrode, the NCM333 obtained as above was used and the positive electrode active material (NCM333) and the positive electrode additive (Li₅FeO₄) were mixed at a mass ratio of 96:4. This cell was assumed to be a three-pole cell D3. The porosity of the positive electrode active material layers in the positive electrode of Example 4-3 was adjusted to 23%.

### Example 4-4

### Preparation of NCM523 Serving as a Positive Electrode Active Material

Li₂CO₃ and a coprecipitated hydroxide represented by Ni_{0.5}Co_{0.2}Mn_{0.3} (OH)₂ were mixed with each other by using an Ishikawa-type grinder mortar so that the molar ratio of Li to all transition metal elements was 1.08:1. The resulting mixture was heat-treated in an air atmosphere at 950° C. for 20 hours and crushed. As a result, Li_{1.04}Ni_{0.5}Co_{0.2}Mn_{0.3}O₂ (hereinafter referred to as “NCM523”) having an average secondary particle size of about 12 μm was obtained.

A three-pole cell was prepared as in Example 1-1 except that, in preparing the positive electrode, the NCM523 obtained as above was used and the positive electrode active material (NCM523) and the positive electrode additive (Li₅FeO₄) were mixed at a mass ratio of 96:4. This cell was assumed to be a three-pole cell D4. The porosity of the positive electrode active material layers in the positive electrode of Example 4-4 was adjusted to 25%.

### Example 4-5

### Preparation of NCA as a Positive Electrode Active Material

LiOH and a coprecipitated hydroxide represented by Ni_{0.8}Co_{0.17}Al_{0.03}(OH)₂ were mixed with each other by using an Ishikawa-type grinder mortar so that the molar ratio of Li to all transition metal elements was 1.08:1. The resulting mixture was heat-treated in an oxygen atmosphere at 800° C. for 20 hours and crushed. As a result, Li_{1.04}Ni_{0.8}Co_{0.17}Al_{0.03}O₂ (hereinafter referred to as “NCA”) having an average secondary particle size of about 12 μm was obtained.

A three-pole cell was prepared as in Example 1-1 except that, in preparing the positive electrode, the NCA obtained as above was used and the positive electrode active material (NCA) and the positive electrode additive (Li₅FeO₄) were mixed at a mass ratio of 96:4. This cell was assumed to be a three-pole cell D5. The porosity of the positive electrode active material layers in the positive electrode of Example 4-5 was adjusted to 24%.

### Comparative Example 4-1

A three-pole cell was prepared as in Example 1-1 except that no positive electrode additive was added and only the positive electrode active material (LiCoO₂) was used. This cell was assumed to be a three-pole cell D6. The porosity of the positive electrode active material layers in the positive electrode of Comparative Example 4-1 was adjusted to 27%.

### Comparative Example 4-2

A three-pole cell was prepared as in Example 1-1 except that no positive electrode additive was added and only the positive electrode active material (NCM333) was used. This cell was assumed to be a three-pole cell D7. The porosity of the positive electrode active material layers in the positive electrode of Comparative Example 4-2 was adjusted to 27%.

### Comparative Example 4-3

A three-pole cell was prepared as in Example 1-1 except that no positive electrode additive was added and only the positive electrode active material (NCM523) was used in preparing the positive electrode. This cell was assumed to be a three-pole cell D8. The porosity of the positive electrode active material layers in the positive electrode of Comparative Example 4-3 was adjusted to 24%.

### Comparative Example 4-4

A three-pole cell was prepared as in Example 1-1 except that no positive electrode additive was added and only the positive electrode active material (NCA) was used in preparing the positive electrode. This cell was assumed to be a three-pole cell D9. The porosity of the positive electrode active material layers in the positive electrode of Comparative Example 4-4 was adjusted to 28%.

The three-pole cells D1 to D9 were charged and discharged as with the three-pole cell A1 and the charge capacities (mAh/cc) and load properties (%) were calculated. After charging and discharging, each of the three-pole cells D1 to D9 were dismantled, the positive electrodes were taken out, and the porosities of the positive electrode active material layers were measured. According to the results, the porosity of the positive electrode active material layers in Example 4-1 and Comparative Example 4-4 was 29%, the porosity of the positive electrode active material layers of Examples 4-2 and 4-4 and Comparative Examples 4-1 and 4-2 was 28%, the porosity of the positive electrode active material layers in Example 4-3 was 25%, the porosity of the positive electrode active material layers in Comparative Example 4-3 was 26%, and the porosity of the positive electrode active material layers in Example 4-5 was 27%.

Table 4 summarizes the compositions of the positive electrode active materials and the positive electrode additives used in Examples 4-1 to 4-5 and Comparative Examples 4-1 to 4-4, the mixing ratio of the positive electrode additive relative to the positive electrode active material, the porosities of the positive electrode active material layers, and the observed charge capacities and load properties (2.0 It).

TABLE 4

| | | | Positive electrode | Porosity | Porosity | Charge | Rate |
|---|---|---|---|---|---|---|---|
| | Positive electrode | Positive electrode | additive mixing | before first | after charging | capacity | characteristic |
| | active material | additive | ratio | charging | and discharging | (mAh/cc) | (2.0 It) |
| Example 4-1 | LiCoO₂ | Li₅FeO₄ | 4% by mass | 27% | 29% | 726 | 86.2% |
| Example 4-2 | Coated LCO | Li₅FeO₄ | 4% by mass | 26% | 28% | 770 | 90.3% |
| Example 4-3 | NCM333 | Li₅FeO₄ | 4% by mass | 23% | 25% | 832 | 85.0% |
| Example 4-4 | NCM523 | Li₅FeO₄ | 4% by mass | 25% | 28% | 738 | 83.6% |
| Example 4-5 | NCA | Li₅FeO₄ | 4% by mass | 24% | 27% | 826 | 83.4% |
| Comparative | LiCoO₂ | None | — | 27% | 28% | 704 | 78.9% |
| Example 4-1 | | | | | | | |
| Comparative | NCM333 | None | — | 27% | 28% | 687 | 65.0% |
| Example 4-2 | | | | | | | |
| Comparative | NCM523 | None | — | 24% | 26% | 756 | 79.2% |
| Example 4-3 | | | | | | | |
| Comparative | NCA | None | — | 28% | 29% | 782 | 39.2% |
| Example 4-4 | | | | | | | |

The results shown in Table 4 indicate that degradation of the rate characteristic was less in Examples 4-1 to 4-5 in which a Li-containing compound that generated gas at 4.2 V (vs. Li/Li⁺) or less during the first charging was used as a positive electrode additive for the positive electrode active material layers than in Comparative Examples 4-1 to 4-4 in which no such Li-containing compound was used. A high charge capacity was observed in all of Examples 4-1 to 4-5 in which the porosity of the positive electrode active material layers was 30% or less.

The results of Examples 4-1 to 4-5 show that while degradation of the rate characteristic was suppressed in a similar manner by using various types of positive electrode active materials, the extent of suppressing degradation of the rate characteristic was high in Example 4-2 in which a rare earth element is attached to a positive electrode active material compared to Examples 4-1 and 4-3 to 4-5 in which no rare earth element was attached to the positive electrode active material. This is presumably because a catalytic action of the rare earth element on the surface of the positive electrode active material accelerated the decomposition reaction of the Li-containing compound particularly at the surface of the positive electrode active material during the first charging, thereby improving the pore-forming state in the positive electrode active material layers and effectively feeding the electrolyte onto the surface of the active material.

### REFERENCE SIGNS LIST

1 negative electrode
2 positive electrode
3 separator
4 battery case
5 sealing plate
6 upper insulating plate
7 lower insulating plate
8 positive electrode lead
9 negative electrode lead
10 positive electrode terminal
30 nonaqueous electrolyte secondary battery

1. A positive electrode for a nonaqueous electrolyte secondary battery, comprising a positive electrode current collector and a positive electrode active material layer disposed on the positive electrode current collector, the positive electrode active material layer containing a positive electrode active material and a positive electrode additive,
wherein the positive electrode additive contains a Li-containing compound that generates gas at 4.2 V (vs. Li/Li⁺) or less during first charging of a nonaqueous electrolyte secondary battery that includes the positive electrode for a nonaqueous electrolyte secondary battery, and the positive electrode active material layer has a porosity of 30% or less before the first charging of the nonaqueous electrolyte secondary battery.

2. The positive electrode for a nonaqueous electrolyte secondary battery according to claim 1, wherein the Li-containing compound has an antifluorite crystal structure.

3. The positive electrode for a nonaqueous electrolyte secondary battery according to claim 1, wherein the Li-containing compound is represented by general formula LiₓM_{y}O₄ (x=4 to 7, y=0.5 to 1.5, and M represents at least one metal selected from Co, Fe, Mn, Zn, A1, Ga, Ge, Ti, Si, and Sn.)

4. The positive electrode for a nonaqueous electrolyte secondary battery according to claim 1, wherein a mixing ratio of the Li-containing compound to the positive electrode active material in the positive electrode active material layer is 0.1% by mass or more and 10% by mass or less.

5. The positive electrode for a nonaqueous electrolyte secondary battery according to claim 1, wherein a rare earth element is attached to a surface of the positive electrode active material.

6. A nonaqueous electrolyte secondary battery comprising the positive electrode for a nonaqueous electrolyte secondary battery according to claim 1, a negative electrode, a separator interposed between the positive electrode and the negative electrode, and a nonaqueous electrolyte.

7. A nonaqueous electrolyte secondary battery comprising a positive electrode, a negative electrode, a separator interposed between the positive electrode and the negative electrode, and a nonaqueous electrolyte,
wherein the positive electrode includes a positive electrode current collector and a positive electrode active material layer disposed on the positive electrode current collector, the positive electrode active material layer containing a positive electrode active material and a positive electrode additive, where the positive electrode additive contains a Li-containing compound that generates gas at 4.2 V (vs. Li/Li⁺) or less during first charging of the nonaqueous electrolyte secondary battery, and
wherein the positive electrode active material layer has a porosity of 33% or less after the first charging of the nonaqueous electrolyte secondary battery.

8. The nonaqueous electrolyte secondary battery according to claim 7, wherein the positive electrode active material layer has a porosity of 15% or more and 33% or less after the first charging.

9. A nonaqueous electrolyte secondary battery comprising a positive electrode, a negative electrode, a separator interposed between the positive electrode and the negative electrode, and a nonaqueous electrolyte,
wherein the positive electrode includes a positive electrode current collector and a positive electrode active material layer disposed on the positive electrode current collector, the positive electrode active material layer containing a positive electrode active material and a positive electrode additive,
wherein the positive electrode additive contains a Li-containing compound that generates gas at 4.2 V (vs. Li/Li⁺) or less during first charging of the nonaqueous electrolyte secondary battery, and
wherein the positive electrode active material layer has a porosity of 30% or less before the first charging of the nonaqueous electrolyte secondary battery and a porosity of the positive electrode active material layer after the first charging is higher than the porosity of the positive electrode active material layer before the first charging.
